(19) United States
(12) Patent Application Publication
(10) Pub. No.: US 2023/0111866 A1
(43) Pub. Date: Apr. 13, 2023

(54) Tiedown Hook for Automobile Accessories

(71) Applicant: Tailai Ting, Pomona, CA (US)

(72) Inventor: Tailai Ting, Pomona, CA (US)

(21) Appl. No.: 17/500,806

(22) Filed: Oct. 13, 2021

(51) Int. Cl. B60P 7/08

(52) U.S. Cl. CPC B60P 7/0807

(57) ABSTRACT

The tiedown hook is a mechanism that welds an inventive hook to an automobile accessory for tying and untying knots with tiedown to secure objects during transportation. The present invention relates to functional tiedown hook for automobile accessories such as truck racks, trailers, etc. More particularly, the inventive concept of the tiedown hook is beneficial since tiedown need to be carefully secured when vehicle is moving.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copy right rights whatsoever.

### DESCRIPTION OF THE INVENTION

This invention pertains to vehicles that have an accessory such as truck rack or trailer to transport objects. This product is designed to accommodate a tiedown tor securing objects on a vehicle when it is moving.

The tiedown hook allows the user to attach a tiedown to the hook melted to the tube or bar of a vehicle accessory such as truck rack or tailor. The tiedown is inserted into the hook by wrapping a couple of turns and a half hitch knot. The number of turns depends on the size of the tiedown.

A ladder rack for truck, that is usually installed on the truck bed of a pickup truck, is usually used to transport large, heavy, and bulky objects such as ladders, lumbers, cargos and etc. Those big objects need to be properly fastened and secured on the racks with tiedown or rope to prevent falling during transportation. This hook could be welded onto the tube or bar of the track rack so the tiedown can be inserted into the hook to secure the objects. The design of the hook with a closed circle would allow to attach tiedown on the hook to face in any directions.

Presently, it is common to tie a tiedown or rope to an open-ended hook (instead of the inventive hook with a closed circle) on automobile accessory such as truck rack or trailer. It is difficult to attach the tiedown on an open-ended book to secure a rope in a stationary position. The use of common open-ended hook results in time consuming tying and untying and often the outcome is the rope being loosen and the objects being unsecure.

The inventive tiedown hook with a closed circle is a safe and appropriate application for its intended use, which is to secure objects onto the truck rack or trailer by tying tiedown or rope through the hook. The welded hook onto these automobile accessories holds more capacity than a mounted hook when securing large objects. And the operation of tying a rope to a closed circle hook is easier and less time consuming compared to tying to an open-ended hook.

### BRIEF DESCRIPTION OF VIEWS OF THE DRAWINGS

There are two views of the invention that describe the parts and how they are made to the specifications necessary to explain the making of the tiedown hook.

FIG. 1

Item 1 is a slightly curved solid bar longer than Item 2. Item 1 is used for a rope or tiedown to wrap a knot around the bar. It is used to secure the rope from slipping off item 2.

Item 2 is a solid arch shaped bars used to allow an approximate half circle space between Item 1 and Item 2. This space is used to tie the rope or tiedown, or for the rope or tiedown to go through to make a knot.

Item 3 indicates the areas that are welded to secure Item 1 to Items 2.

FIG. 2

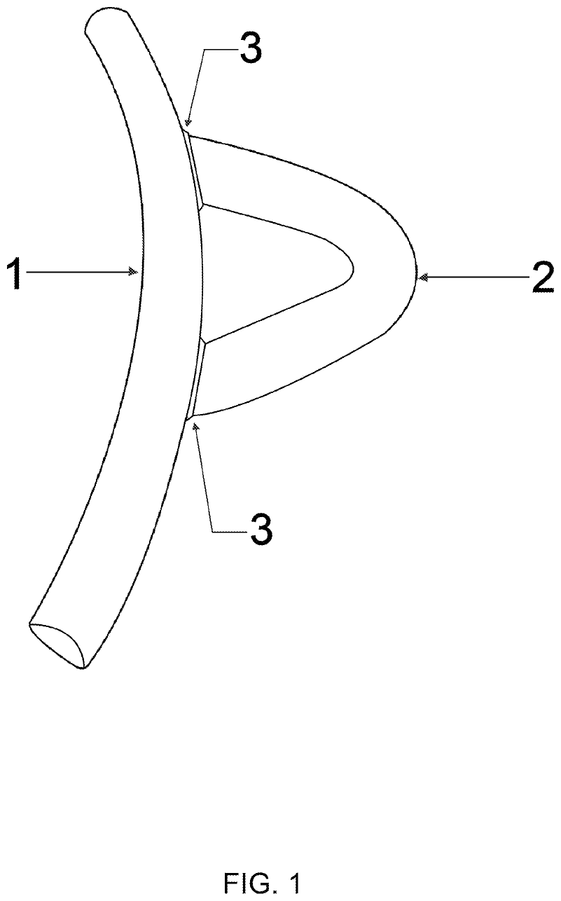

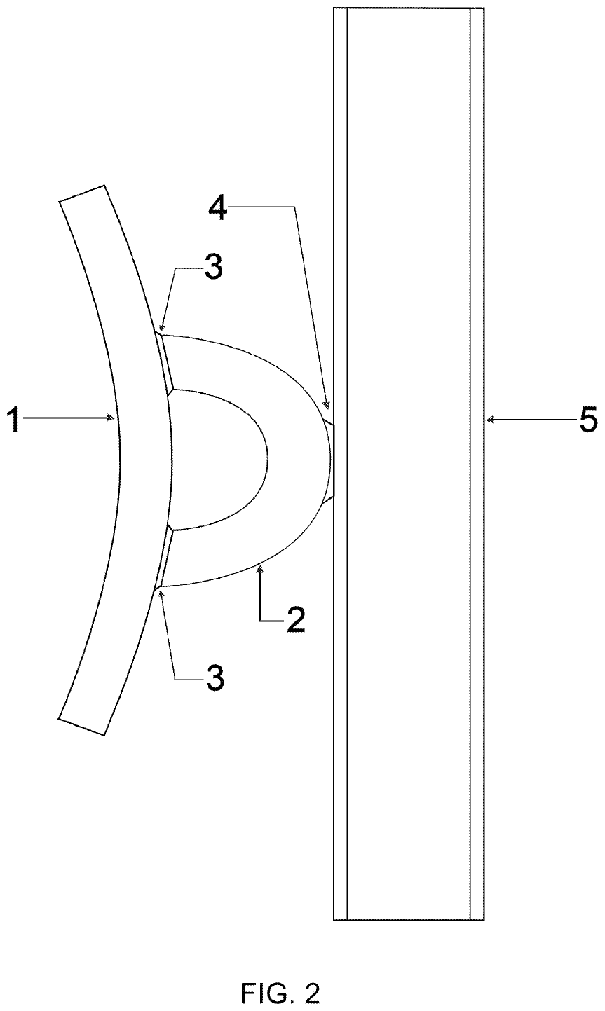

Item 1 through Item 3 are described in the description of FIG. 1.

Item 4 shows a tubing or a bar of an automobile accessory such as truck rack or trailer.

Item 5 indicates the areas that are welded to secure Item 2 to Items 4.

1. This is claimed to be a piece of tiedown hook that mounts to a tubing or a bar of an existing automobile accessory, such as truck rack or trailer, for the purpose of tying rope or tiedown easily and strongly to secure objects on moving automobile accessories.

2. This tiedown hook, as recited in claim 1, wherein said tiedown hook is fit on any tubing or bar of a truck rack, ladder rack, and trailer.

3. This tiedown hook, as recited in claim 2, wherein said tiedown hook can be made of aluminum, steel, stainless, titanium, magnesium, brass, bronze, reinforced plastic, or any material of suitable strength.

4. This tiedown hook, as recited in claim 3, wherein said tiedown hook can be bolted instead of welded or forged or east as a single piece.
